(19) United States
(12) Patent Application Publication
(10) Pub. No.: US 2007/0134641 A1
(43) Pub. Date: Jun. 14, 2007

(54) Personalized content delivery

(75) Inventor: Winston Hong Lieu, Holmdel, NJ (US)

Correspondence Address: DEMONT & BREYER, LLC, 100 COMMONS WAY, HOLMDEL, NJ, 07733, US

(73) Assignee: Mobicom Corporation, Holmdel, NJ (US)

(21) Appl. No.: 11/297,100

(22) Filed: Dec. 8, 2005

(51) Int. Cl. G09B 3/00

(52) U.S. Cl. 434/350

(57) ABSTRACT

A method and apparatus for use in conjunction with a “push” approach to multimedia content delivery is disclosed. Content that is received by the client is stored in memory. Items of content that are of interest to the user are “preserved” in memory by the user. Feedback relating, among other things, to which items of content have been preserved is returned to the server. Additional content, which is based on the user feedback, is sent to the client. The additional content overwrites items of content that have not been preserved by the user.

### FIELD OF THE INVENTION

The present invention relates to the delivery of multimedia content.

### BACKGROUND OF THE INVENTION

There has been tremendous growth in the amount of information that is distributed over computer networks, such as the Internet. The information is usually presented in one of several formats, including video, audio, graphics, or text (hereinafter “multimedia content”).

There are two basic approaches to the delivery of multimedia content over the Internet. One approach is “pull,” wherein a user “pulls” content from a server. That is, using a browser, a user locates (e.g., via “surfing,” etc.) desired content and requests its delivery from a server that is responsible for the content. The server responds, in some cases after appropriate authorization and payment, by transmitting the requested content for presentation to the user's browser. The other approach is “push,” wherein a content provider sends generally unsolicited information, such as advertisements, over the Internet for presentation to a user.

Recent advances in information processing technologies have resulted in Internet-enabled, hand-held, wireless terminals (e.g., mobile phones, etc.) that provide a user with the ability to access the Internet remotely. Notwithstanding this capability, obtaining multimedia content this way is somewhat problematic due, at least in part, to limitations of the user interface of such devices.

In particular, wireless, hand-held devices have a relatively small-sized display. This limits the amount of content that can be viewed at one time. A second interface-related shortcoming relates to a limited ability to enter language (i.e., words) into a wireless hand-held device, as might be required to obtain content from a server. Typically, words are entered using numerals “2” through “9” of the hand-held's keypad, wherein each key is used to access at least three letters. Alternatively, a virtual keyboard appears in the display, wherein navigation keys are used to select letters, one by one, to spell a word. And although some Internet-enabled PDAs include a full keyboard, it's quite small, so that entering text remains cumbersome. The aforementioned limitations relating to display size and the key set renders Internet “surfing” tedious, if not intolerable.

In fact, due to these and other limitations (e.g., limited bandwidth, connectivity problems, etc.), multimedia content that is intended for a hand-held device is often first downloaded to computer and then uploaded to the hand-held device. Although this requires the intermediate step of downloading to a desk-top computer, the availability of a far superior user interface on the desk-top has until now more than compensated for this additional downloading step.

Another way to address these problems is for a content provider to push the multimedia content to a user, rather than requiring the user to pull it from the provider. This minimizes or alleviates a user's need to surf, such that the compromised user interface of hand-held devices is of somewhat decreased significance.

There are, however, problems associated with pushing multimedia content to a user. Consider, for example, a content provider that pushes music files to a user. Without some knowledge of a user's taste in music, there is little chance that the music that the user receives would be of interest. Some of the problems that arise when pushing multimedia content are addressed in U.S. Published Patent Application 2004/0068552 (“the '552 application), which discloses methods and apparatus for personalized content presentation.

According to the '552 application, cooperating client and server processes interact to dynamically tailor multimedia content that is pushed to a user. The client provides user identification information and feedback to the server so that the server can identify recommended content based on the identity of the user. A list of recommended content is pushed to the client, so that a user can select content from this list. The user's selections are transmitted to the server. The server then delivers the requested content.

The user's selections serve as a first form of feedback. That is, the selections inform the server of the user's preference for the selected content over the non-selected content from the list. In addition, the '552 application discloses that a user has the ability to rate the items in the recommended content list and provide the rating information to the server as a second form of feedback. All information that is returned to the server is used to update the server's model for future recommendations of multimedia content for the user.

According to the '552 application, since the server only delivers requested content (from the list), the limited bandwidth that is available for wireless transmission is used far more efficiently than would be the case if the content were not personalized.

The use of feedback, as described in the '552 application, improves the efficiency of a push model. But there are some drawbacks to the methods and apparatus that are disclosed in the '552 application. For example, according to the '552 application, a list of recommended content, such as a list of songs, is sent from the server to the client/user. The user is then asked to select content from the list and then communicate the selections to the server. Only after the user's picks are communicated to the server is the selected content sent to the client/user. But selection of content from the list presupposes a user's familiarity with the content. In other words, if a user has not heard the songs that appear in a list of recommended songs, there is no basis for the user to select from among the songs that appear in the list.

### SUMMARY OF THE INVENTION

The present invention provides a method and apparatus for use in conjunction with a “push” approach to multimedia content delivery without some of the costs and disadvantages of the prior art.

In accordance with the invention, desired multimedia content, such as music, video, news items, and the like, is pushed from a server to a client. In the illustrative embodiment, the client is a hand-held device that has wireless capability, an ability to present multimedia content (to a user), and access to the data network, such as the Internet.

The multimedia content that is received by the client is stored in its memory and is immediately accessible by a user. If a user does not wish to preserve an item of the received content for repeated access, then the user takes no further action vis-à-vis the item. If, on the other hand, the user wishes keep an item for an extended period of time, then the user must “preserve” it, which is accomplished by a keystroke, etc.

In accordance with the illustrative embodiment, the content that is pushed to the user is dynamically tailored to that user's tastes based on feedback from the user. Several types of feedback are sent from the client/user to the server. A first type of feedback consists of a user's choices regarding which of the various items of the received multimedia content are preserved (or not preserved). A second type of feedback consists of a user's patterns of usage of the preserved multimedia content, including, without limitation, the frequency at which individual content items are accessed and the length of time that they are preserved in memory.

A specific (limited) amount of memory is allocated or otherwise available for storing the multimedia content at the client. To the extent that a user preserves some of the multimedia content that has been forwarded by the server, less memory is available for a subsequent push of multimedia content. In some embodiments, the subsequent push of content from the server to the client/user therefore contains an appropriately reduced amount of multimedia content. Multimedia content within memory (from the previous push) that has not been preserved by the user is overwritten by newly-received multimedia media content. Preserved content is protected; that is, it cannot be overwritten by incoming content.

In the illustrative embodiment of the present invention, substantially no user interaction is required before the user receives multimedia content. This is in stark contrast to the prior art, such as the '552 application, wherein significant user interaction is required before receiving content. For example, the '552 application discloses that a user must first receive a list of recommended content, second select items from a list, third transmit the list to a server, and finally wait to receive the desired content, such as the actual music files, etc.

The present approach whereby content is delivered without user interaction provides several benefits relative to the prior art. One benefit is that content can be delivered whenever the wireless terminal and the server are in communication. Content can be updated during off hours, such as when the device is charging, or when the user is otherwise not present.

Since unsolicited (but personalized) content is being sent to the user, the user will almost certainly receive content, music for example, that they are unfamiliar with. Using the present system, after listening to an unfamiliar tune, a user can choose to preserve it or not. But the user gets to hear it before making a decision. In a system such as the one described in the '552 application, a list of song titles is first forwarded to the user, rather than the songs themselves. It is likely that some of the song titles will be unfamiliar to the user. That being the case, the user might decide not to select unknown music for download. As a consequence, the user will miss the opportunity to be exposed to new music that they might ultimately enjoy.

Alternatively, a user of the prior-art system might decide to take a chance and select unfamiliar music. According to the '552 application, the user's selection of content for download is a form a feedback upon which the server bases subsequent content recommendations. To the extent that a user is routinely selecting unknown music for download, there is a reasonable likelihood that some portion of that unknown music will not be to the user's liking. These selections will necessarily be communicated to the server as feedback and, therefore, form the basis for future content recommendations from the server. This will result in an increased incidence of unsatisfactory recommendations from the server. This decreases the efficiency of the “personalization engine” that is disclosed in the '552 application, and destroys an advantage of that approach—namely, efficient use of bandwidth.

A further benefit of the illustrative embodiment of the present invention is that user feedback is implicit. That is, the feedback is developed “automatically” by the client, whereby the client device simply tracks a user's patterns of usage of the multimedia content. The usage patterns are transmitted to the server where they are analyzed for the purpose of making future content recommendations. Unlike the system that is disclosed in the '552 application, there is no opportunity or need to explicitly rate any item of received multimedia content. The present approach to implementing user feedback enables the use a device with a very limited user interface—such as a hand-held device.

In some other embodiments of the present invention, rather than pushing personalized multimedia content to an individual, it is pushed to a defined group of users. The group, for example, might be users with a similar interest (e.g., sports, classical music aficionados, etc.) or vocation. In some of these embodiments, the content selections and patterns of content usage of one or more members of the group, which is provided as feedback to the server, forms the basis for the multimedia content that is pushed to all group members.

A feature of some embodiments of the present invention is the designation of one or more “favorite” places. A favorite place might be, for example, a stadium, concert hall, a restaurant, a store, etc. In some embodiments, the designation is performed in conjunction with GPS or other location-determining systems.

The designation of a location as a “favorite place” can be performed explicitly or implicitly (or both). As to explicit designation, when a user is at a location that they wish to designate as a “favorite place,” the user simply selects a “favorite-place” icon or pushes a “favorite-place” key. Regarding implicit designation, favorite places are automatically defined based on usage patterns of a user. Specifically, in conjunction with a location-determining system, software regularly monitors the location of the client. The software identifies locations that are visited relatively more frequently or at which the client spends relatively more time. Those location(s) are as designated as “favorite places.” Whether explicitly or implicitly defined, the use of a location-determining system avoids the use alphanumeric characters to define a favorite place.

A list of the favorite places is maintained in a user database at the server. As appropriate, the server pushes information relevant to the favorite place(s) to the user. That information could be, for example, a schedule of events for the selected stadium during the current month, a list of performers that will be playing in the selected concert hall during that season, an announcement of a wine-tasting at a selected restaurant, or a sale at a selected store.

A method in accordance with the illustrative embodiment comprises: receiving first content from a server; storing the first content in a plurality of storage locations; receiving a request to preserve a first subset of the first content; preserving the first subset of the first content in a subset of the storage locations; and sending feedback to the server, wherein the feedback comprises user preferences relating to the first content.

An apparatus in accordance with the illustrative embodiment comprises: a receiver for receiving a plurality of content items from a server; a memory for storing the plurality of content items; circuitry for presenting the content to a user; a selector by which a user preserves at least some of the content items in the memory; and a feedback mechanism, wherein the feedback mechanism compiles and sends feedback to the server.

### BRIEF DESCRIPTION OF THE DRAWINGS

FIG. 1 depicts a system for pushing personalized multimedia to a client.

FIG. 2 depicts further details of the system of FIG. 1.

FIG. 3 depicts a block diagram of a client device for use in conjunction with the system of FIG. 1.

FIG. 4 depicts a combined flowchart and data flow diagram depicting the operation of the server and client.

FIG. 5A depicts several memory locations of the client device of FIG. 3 after a first delivery of multimedia content.

FIG. 5B depicts the memory locations of the client device of FIG. 3 after a second delivery of multimedia content.

FIG. 5C depicts the memory locations of the client device of FIG. 3 after a third delivery of multimedia content.

FIGS. 6A-6C depict an embodiment of the user interface of a client device for use in conjunction with the illustrative embodiment of the present invention.

FIG. 7 depicts a histogram that is representative of a first usage statistic, which is included as feedback to the server.

FIGS. 8A through 8C depict histograms that are representative of a second content-usage statistic, which is included as feedback to the server.

### DETAILED DESCRIPTION

The illustrative embodiment of the invention is a system in which a server pushes multimedia content to a client. The server receives feedback from the client concerning the content, with the intent of increasing the likelihood that subsequent selections of content by the server will be of interest at the client side.

The illustrative system is particularly adapted to require little in the way of explicit input from a user. That is, efficient use of the system requires nothing more on the part of the user than simply accessing the content that has been received from the server. In view of this minimalist approach, the system is very well suited for use in conjunction with devices that have relatively limited or otherwise compromised user-interface capabilities, such as wireless, hand-held devices.

In some embodiments, the system is used in conjunction with methods and apparatus disclosed in applicant's co-pending U.S. patent application Ser. No. ______, entitled “Method and Apparatus for Downloading Content to a Wireless Terminal” (Atty. Dkt. 490-024us). The referenced application discloses a system whereby content, which is available on a subscription basis, is automatically downloaded from a server directly to a hand-held wireless terminal. In the referenced application, content is selected by the user, as opposed to being selected by the server as in the push approach that is described herein. But some of the methods and apparatus disclosed in the referenced application, such as those that minimize a user's need to enter information (e.g., authentication codes, access codes, etc.) into a client device for transmission to a server before receiving multimedia content, can be applied to the present invention to enhance its utility.

While the illustrative embodiments depict the invention being used in conjunction with wireless communications systems, the invention can be used in conjunction with a wire-line system, as well.

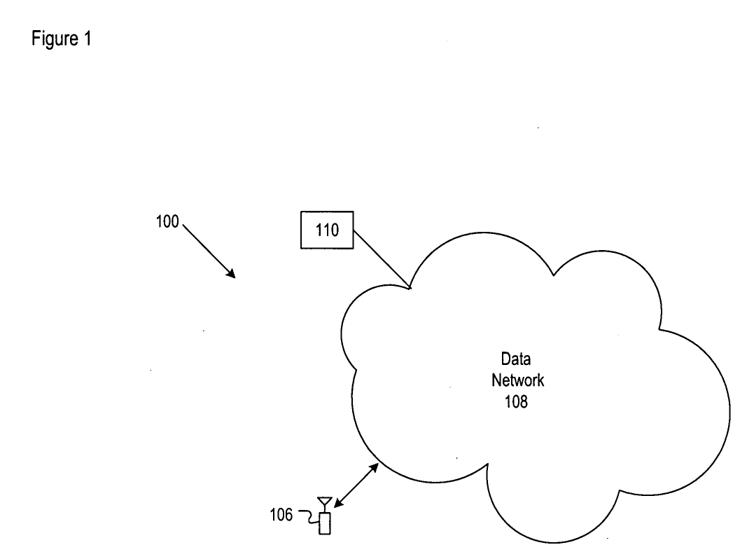

FIG. 1 depicts a schematic diagram of system 100 by which personalized information content is delivered to a user. System 100 includes wireless client 106, data network 108 and server 110.

Wireless client 106 is a hand-held device that:
(i) has wireless capability;
(ii) has an ability to present multimedia content (to a user); and
(iii) has access to a data network, such as the Internet.
   In various embodiments, wireless client 106 is an mp3 player, a mobile phone, a personal digital assistant, a game controller, a digital camera, a video camera, a television, or other device that possesses, in addition to any other functionality, at least the three capabilities listed above.

Wireless client 106 is capable of receiving information from and transmitting information to server 110 of data network 108. Data network 108 (e.g., a WAN, such as the Internet, a LAN, etc.) includes a plurality of network elements, or “nodes,” which can be, for example, a server, a switch, etc.). Server 110, which is a node of network 108, provides personalized content to wireless client 106.

Transfer of information between wireless client 106 and server 110 can be supported via any of a number of protocols (e.g., cellular, WiFi, WiMax, etc.).

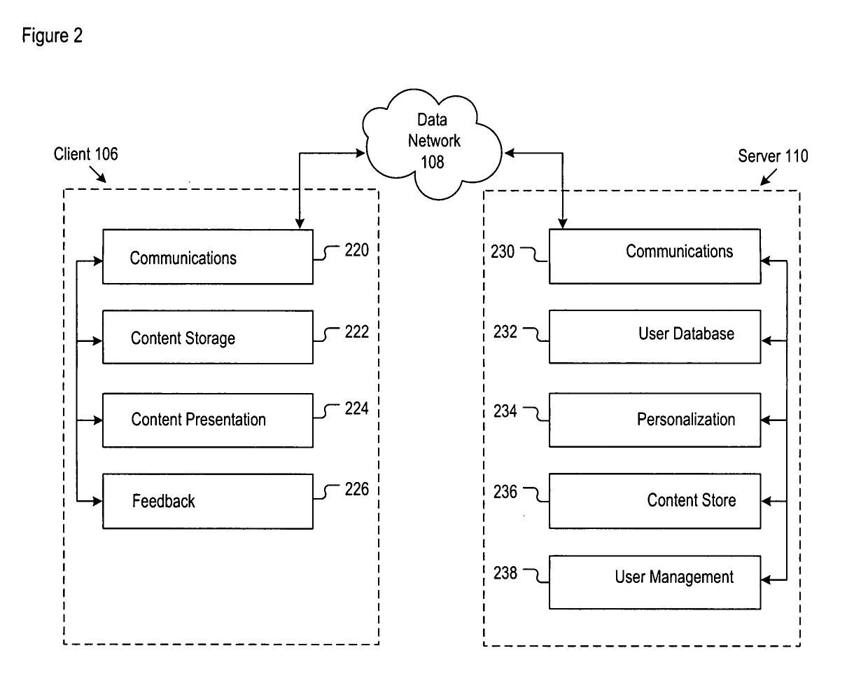

FIG. 2 depicts the salient functionality of client 106 and server 110 of system 100.

As depicted in FIG. 2, client 106 includes the following functional elements: communications functionality 220, content-storage functionality 222, content-presentation functionality 224, and feedback functionality 226.

Communications functionality 220 enables client 106 to receive multimedia content from server 110. It also enables client 106 to transmit information (e.g., authentication codes, information concerning the available memory within client 106, feedback concerning the multimedia content, etc.) to server 110. Communications functionality 220 includes the ability to communicate with server 110 using standard communications protocols of the Internet, including, for example, TCP/IP, HTTP, and FTP protocols. Those skilled in the art will know how to configure client 106 to communicate via these standard protocols or other protocols, as appropriate. Although not germane to the invention, it will be understood that in embodiments in which client 106 includes cellular communications capability, communications functionality 220 will permit typical cellular communications with wireless or wireline phones as well.

Content-storage functionality 222 provides client 106 with a capability of storing multimedia content that is received from server 110. Those skilled in the art will know how to make and use memory that is suitable for providing this function.

Content-presentation functionality 224 provides client 106 with the ability to present multimedia content to a user. As used herein in this specification, the term “present” or “presenting” means to output multimedia content to a user. The manner in which the content is presented is dependent on the nature of the content. For example, the term “present” is synonymous with “play” in the context of a music file, while it is synonymous with “view” in the context of video or text, etc. Those skilled in the art will know how to implement this functionality in client 106.

Feedback functionality 226 provides server 110 with user feedback relating to the multimedia content that it pushed to client 106. In accordance with the illustrative embodiment of the invention, the feedback is developed “automatically” by client 106 based on the user's choices regarding the preservation of selected multimedia content and the user's patterns of usage of the preserved content. Those skilled in the art will how to provide feedback functionality within client 106.

As depicted in FIG. 2, server 110 includes the following salient functional elements: communications functionality 230, user-database functionality 232, personalization functionality 234, content-store functionality 236, and management functionality 238.

Communications functionality 230 enables server 110 to transit multimedia content to client 106 and to receive authentication codes, client/user attributes and feedback from client 106. In some embodiments, this is accomplished by server 110 via standard protocols. Server 110 also provides additional network-related communication services that are common to most servers. Those skilled in the art will know how to implement this communications functionality.

User-database functionality 232 maintains database information regarding the client/user, such as device information, content preferences and other feedback, attributes, location, etc. This functionality can be implemented via a relational database, an object-oriented database, etc. Those skilled in the art will know how to make and use a database to provide this functionality.

Personalization functionality 234 uses feedback and other user-attribute information to select content for delivery to client 106. Since the selection is based on user preferences, the selected content is more likely to be of interest to the intended recipient than a random selection of content. Personalization functionality 234 is implemented via a suitable methodology, including, without limitation, those disclosed in U.S. Pat. Appl. Publ. US 2004/0068552, which is incorporated by reference herein.

Content-store functionality 236 provides a repository for multimedia content. In some embodiments, meta-data is associated with each item of stored multimedia content. The meta-data includes characterization information for the content items. The meta-data facilitates the selection of content items in conjunction with the personalization functionality 234. That is, in some embodiments, personalization functionality 234 identifies characteristics or attributes of a user's preferred content. Those characteristics are compared against the meta-data for the various content items to select content for transmission to client 106. In some other embodiments, meta-data is not used in conjunction with content selection at server 110.

Management functionality 238 maintains database information regarding the user. The management system records user information in such a way that it is structured and indexed for efficient retrieval. The management functionality is advantageously implemented as a database management system appropriate for particular the user database structure (e.g., relational, object-oriented, etc.).

As indicated above, in the illustrative embodiment, client 106 is a device that: (i) has wireless telecommunications capability; (ii) has an ability to present multimedia content to a user; and (iii) can communicate with a data network, such as the Internet.

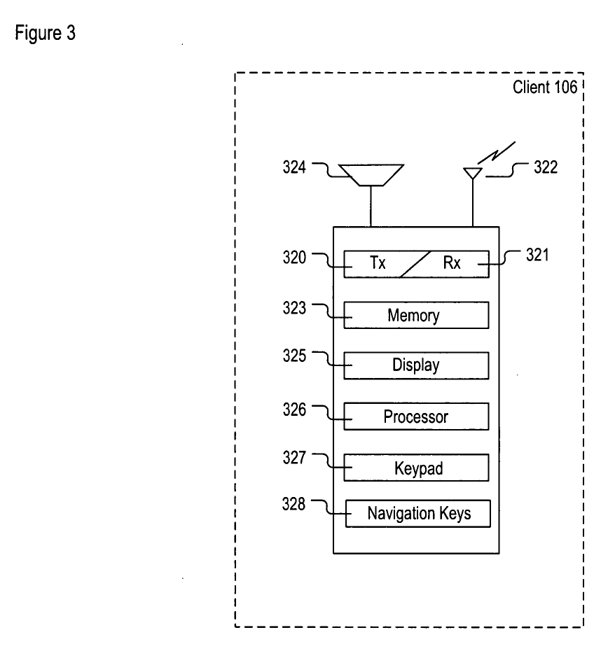

FIG. 3 depicts an illustrative embodiment of client 106. The illustrative embodiment of client 106 is a device that, in addition to possessing the functionality disclosed in FIG. 2, also includes cellular telecommunications capabilities and is hand-held, such as a mobile phone.

Other examples of devices that are hand-held, that can be outfitted with cellular or other wireless telecommunications capability, and that can be modified to include the functionality required for practicing the invention include, without limitation, a personal digital assistant, game controller, digital camera, mp3 player, video camera, television, and the like.

As depicted in FIG. 3, the illustrative embodiment of client 106 includes transmitter 320, receiver 321, antenna 322, memory 323, speaker 324, display 325, processor 326, keypad 327 and navigation keys 328. As those that are skilled in the art will recognize, a mobile phone, for example, includes a variety of other elements that are not depicted, such as a speaker, a battery, etc. Such other elements are not depicted and will not be described because they are not germane to an understanding of the present invention.

Transmitter 320, receiver 321, and antenna 322 provide wireless telecommunications capability for client 106 in known fashion, thereby providing the aforementioned communications functionality 220 (see FIG. 2 and the accompanying description).

Memory 323 is typically implemented as random-access memory (RAM), but can include any combination of RAM, flash memory, disk drive memory, and so forth. For the illustrative embodiment, memory 323 provides the aforementioned content-storage functionality 222 (see FIG. 2 and the accompanying description).

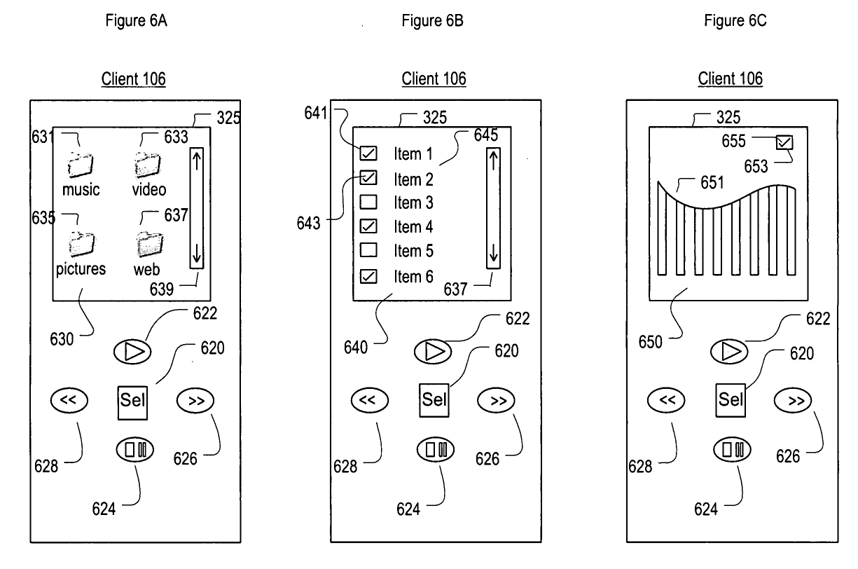

Speaker 324 is capable of outputting an acoustic signal (e.g., music, etc.). Display 325 is a visual display, typically LCD, that enables wireless terminal 106 to output information (e.g., text, images, video, etc.). For the illustrative embodiment, speaker 324, display 325, or both, provide the aforementioned content-presentation functionality 224 (see FIG. 2 and the accompanying description). Another element of the content-presentation functionality is a graphical user interface (“GUI”), which is described further in conjunction with FIGS. 6A through 6C.

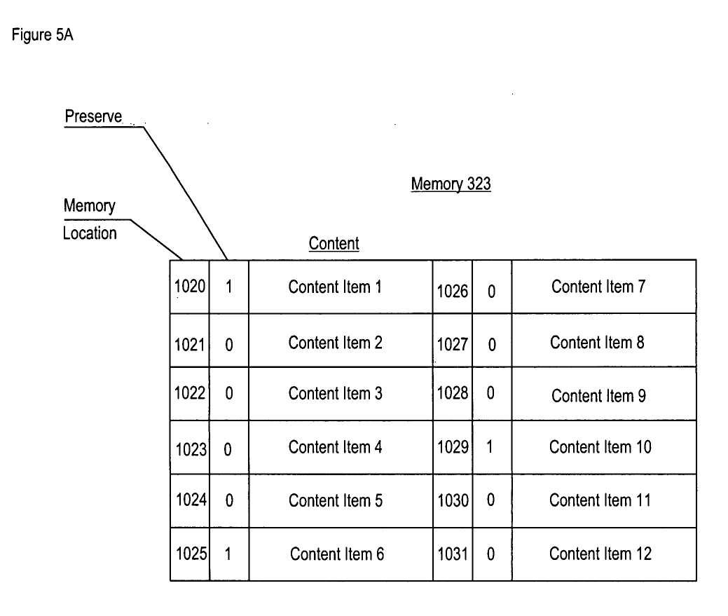

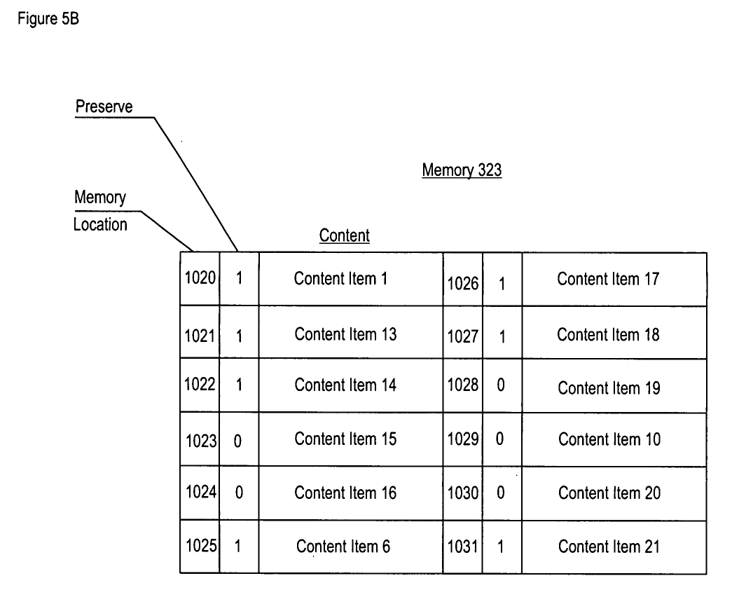

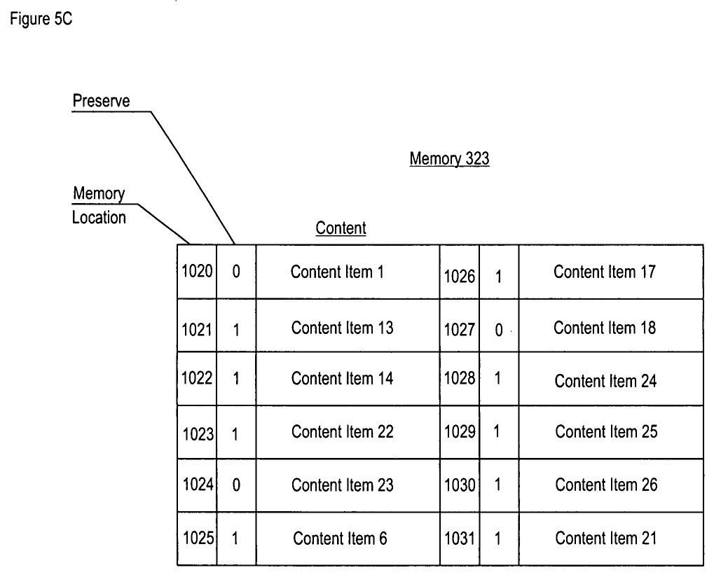

Processor 326, which includes associated control circuitry, is capable of coordinating and controlling the various components of client 106 to provide the requisite functionality of FIG. 2. Among other capabilities, processor 202 is capable of executing instructions stored in memory 323, of reading data from and writing data into memory 323, and of executing the tasks described below and with respect to FIGS. 5A-5C, 6A-6C, 7, and 8A-8C. Processor 326 is a suitably programmed general-purpose processor or, alternatively, can comprise special-purpose hardware. In either case, it will be clear to those skilled in the art how to make and use processor 326.

Keypad 327 is a tactile input device consisting of a plurality of keys that enables client 106 to receive information from a user. Keypad 327 is typically used to place a cellular call. Navigation keys 328 are also tactile input devices that enable a user to “navigate” menus and select menu items. More particularly, as will be described in further detail in conjunction with FIGS. 6A through 6C, navigation keys 328 enable a user to preserve multimedia content in memory 323, request presentation of the multimedia content, and so forth.

In some embodiments, keypad 327 is not present; that is, client 106 only includes navigation keys 328. An example of such an embodiment is when client 106 is an MP3 player. The keypad is not necessary or desired since alphanumeric input, such as to place a cellular phone call, is not required.

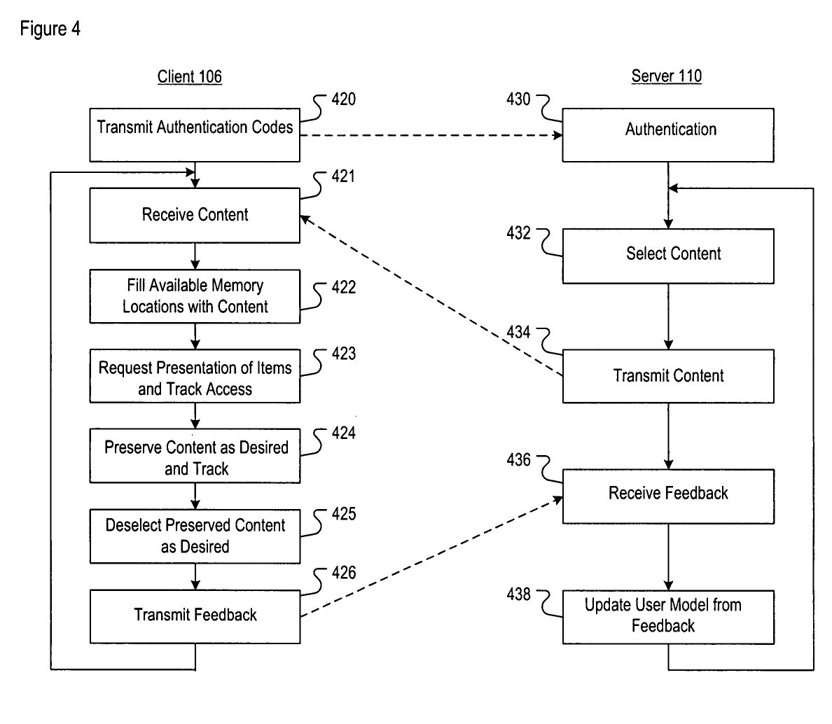

FIG. 4 is a combined flowchart and data flow diagram depicting the salient operations of client 106 and server 110 as well as communications that occur therebetween. The directed, dashed arrows shown in FIG. 4 are indicative of data flow between client 106 and server 110. Operations 420 through 426 are conducted at client 106 and operations 430 through 438 are conducted at server 110. Although some of the operations depicted in FIG. 4 logically precede or follow other operations, as will be appreciated by those skilled in the art, the order of operations shown in FIG. 4 is simply for pedagogical purposes. It is to be understood that the operations conducted at client 106, at server 110, or at both the client and the server can and most likely will be carried out in an order that is different than shown in FIG. 4.

Turning now to the operations that occur at client 106, at operation 420, user identification information (e.g., authentication codes, etc.) is transmitted to server 110. In some embodiments, information concerning the amount of memory 323 that is available for receiving multimedia content is transmitted to server 110 at operation 420.

Assuming that the user/client is authenticated by server 110, client 106 receives content from server 110 at operation 421. This can occur at any time, as long as client 106 is operational; a user does not need to be present or otherwise take any action to initiate and receive multimedia content from server 110.

Multimedia content that is received at client 106 fills available locations within memory 323. In some embodiments, information relating to the amount of memory at client 106 that is available for receiving multi-media content is provided to server 110. In such embodiments, an appropriate quantity of content is sent from server 110 to client 106. This provides for efficient utilization of the available bandwidth.

At a convenient time, a user makes a request to client 106 to present one or more items of content at operation 423. The request is made by my accessing certain menus, as described further in conjunction with the description of FIGS. 6A through 6C.

Client 106 keeps track of each request it receives from the user to present a particular content item. Client 106 also optionally tracks other access-related statistics, such as the time of day that a content item is presented, the order in which items are presented, the location of client 106, etc.

Content that a user wishes to preserve in memory is so designated at operation 424. As described later in this specification, in some embodiments, to “preserve” a content item, a user simply selects (i.e., “clicks on”) an icon, etc., or presses a key of client 106. This action “sets a bit” in memory 323 that indicates that the selected content item is to be preserved.

Content that the user does not wish to maintain is not designated as “preserved.” In some embodiments, this occurs by simply taking no action with respect to content that is of no interest. As a consequence, when a subsequent transmission of content is received at client 106, content that has not been explicitly “preserved” will be overwritten. That is, the newly-received multi-media content will occupy the memory that was formerly occupied by the unpreserved content. If, on the other hand, a bit was set indicating that the content item is to be preserved, the associated memory location is protected so that the preserved content cannot be overwritten.

After a period of time, a user might wish to “un-preserve” a content item that has been preserved. This is accomplished at operation 425, which is described later in this specification in conjunction with FIGS. 6A through 6C.

Statistics related to access of the multi-media content, as tracked at operation 423, and statistics as to which content items are preserved as opposed to not preserved, as tracked at operation 424, are transmitted to server 110 at operation 426 as “feedback.” As described further below, the feedback is used to develop recommended content for subsequent transmissions by server 110.

Turning now to server 110, the server receives user information from client 106 and authenticates (as appropriate) the user at operation 430.

Operations 432 through 438 at server 110 are iteratively operable to exchange information with client 106. At operation 432, server 110 selects content to be transmitted to client 106. Selection is based on a model that advantageously incorporates the feedback provided by client 106. The feedback is used to tailor content recommendations to the user based on the user's past selections and usage history.

In some embodiments, the amount of content that is selected for transmission to client 106 is based the amount of memory that is available at the client. Since, in those embodiments, no more content will be transmitted to client 106 than can be received into memory, bandwidth is efficiently utilized.

In some embodiments, the amount of multimedia content that is selected is based on a consideration of (1) the amount of memory that is available at client 106 as well as (2) the amount of content that client 106 is authorized to receive. The reason for this is that in some embodiments, a user will subscribe to a service to receive a certain amount of multimedia content (see, e.g., “Method and Apparatus for Downloading Content to a Wireless Terminal” (Atty. Dkt. 490-024us)). The authorized amount of content might require less storage space than is available at client 106 for storing multimedia content. As a consequence, it is important for server 110 to verify the amount of content that a client/user is authorized to receive.

At operation 434, server 110 transmits the selected content to client 106. Since the actual content, as opposed to a list of content, is forwarded, the user can enjoy the content immediately.

At operation 436, server 110 receives feedback from client 106. The feedback is used to develop recommended content for subsequent transmissions by server 110.

FIGS. 5A-5C, 6A-6C, 7, and 8A-8C provide further information concerning the manner in which content is preserved at client 106 and feedback is developed.

FIGS. 5A through 5C depicts the contents of a portion of memory 323 allocated for the storage of multimedia content. It is to understood that the depiction of a particular content item being contained at a particular memory location is for pedagogical purposes.

FIG. 5A depicts memory 323 after a first delivery of multimedia content to client 106 from server 110. The content, which is identified as content items 1 through 12, is stored in respective memory locations 1020 through 1031. For the purpose of this illustration, it is assumed that memory locations 1020 through 1031 represent all locations that are available for multimedia content storage.

At any time after the content is received by client 106, a user can request presentation of the content. Such a request involves navigating one or more menus that include appropriate selection options. Illustrative menus and selection options included in an exemplary graphical user interface for client 106 are depicted in FIGS. 6A through 6C. These Figures, and a description of the manner in which a user accesses multimedia content and preserves it in accordance with the illustrative embodiment of the present invention, are described later in this specification.

Continuing with a description of FIG. 5A, which shows the status of memory 323 after a first transmission or push of content, the user has preserved content item 1 (at location 1020), content item 6 (at location 1025), and content item 10 (at location 1028). The status of the “preserve” bit is shown as a “1” for those content items, and as a “0” for non-preserved content items.

The information pertaining to preserved content items is transmitted, as per operation 426 (FIG. 4), from client 106 to server 110 as a first type of feedback. As previously described, this feedback is used by the server 110 to develop further content recommendations using appropriate algorithms. In some embodiments, information relating to the amount of memory 323 that is occupied by non-preserved content (or by preserved content) is forwarded to server 110. This information is used by server 110 to ensure that an appropriate amount of content is forwarded to the client during a subsequent transmission, providing for an efficient use of bandwidth.

In some alternative embodiments, server 110 possesses requisite information concerning the total memory capacity available for multimedia storage. This information, in conjunction with feedback concerning which content items were preserved, enable server 110 to determine the amount of memory that is available to receive content. This enables server to select an appropriate amount of content for transmission to client 106.

As previously described, in some embodiments, server 110 verifies the amount of multimedia content that client 106 is authorized to receive, as well as the amount of memory that is actually available, before transmitting content to client 106.

FIG. 5B shows the state of memory 323 after a second delivery of content from server 110 and after the user has made choices concerning which of the content items to preserve.

As depicted in FIG. 5B, content items 1, 6 and 10, which were preserved by the user, remain in memory. New content items 13 through 21 have filled the remaining memory locations, overwriting content items at memory locations 1021-1024, 1026-1028, and 1030-1031. As to the new content items, the user has chosen to preserve items 13, 14, 17, 18, and 21. As to the original content items, the user has chosen to “un-preserve” or de-select previously-preserved content item 10. This de-selection operation is described later in conjunction with FIGS. 6A through 6C.

Note that while only three content items were preserved from the first transmission of content, five items from the second transmission were preserved. This is the expected result from using feedback to tailor content recommendations.

FIG. 5C depicts the state of memory 323 after a third delivery of content from server 110 and after the user has made choices concerning which of the content items to preserve.

As depicted in FIG. 5C, previously-preserved content items 1, 13, 14, 6, 17, 18, and 21 remain in memory. New content items 22 through 26 fill the remaining memory locations by overwriting content items at memory locations 1023-1024 and 1028-1030. As to the new content, the user has chosen to preserve items 22 and 24-26. As to the content that had a “preserved” status after the second delivery (i.e., items 1, 13, 14, 6, 17, 18, and 21), the user has chosen to un-preserve content items 1 and 18.

The user is likely accumulate content over time, with the result that fewer locations are available for subsequent content transfers from server 110. For example, after the first transfer (FIG. 5A), three out of twelve possible memory locations were preserved, while after the third transfer (FIG. 5C), nine out of twelve locations were preserved. These numbers are not intended to be representative of the actual contents of a memory, but rather serve to illustrate the expected trend of decreasing availability of memory locations. Of course, that situation can be readily remedied, as desired, by simply un-preserving some of the accumulated content.

In some embodiments, when only a small amount of memory capacity is available (or when none is available) for storing additional multimedia content, the user is alerted. This situation can arise as a consequence of a physical limitation (i.e., the memory is full) or a subscription-based limitation (i.e., the user has preserved all the content that they are authorized to preserve).

In some embodiments, a message to alert the user to the capacity limitation is generated by server 110; in other embodiments, client 106 identifies the capacity limitation and alerts the user.

If the problem is a subscription limitation, then it can be addressed by either increasing the authorized amount of content under the subscription or by un-preserving content items. If the problem is due to a physical limitation on storage capacity, then the user must un-preserve content items.

FIGS. 6A through 6C depict an illustrative embodiment of a user interface by which a user interacts with client 106. In these Figures, client 106 is configured as a multimedia player that incorporates the requisite wireless and content-presentation functionality, etc., to be used in conjunction with personalized content delivery system disclosed herein.

For the embodiment of client 106 that is depicted in FIGS. 6A through 6C, only navigation keys 328 are included (no keypad). For the illustrative embodiment, navigation keys 328 include “sel” key 620, “play” key 622, “stop/pause” key 624, “next” key 626, and “back” key 628. The function of the key depends upon the state of client 106; that is, which particular “screen” or “menu” is active.

To present a content item, a user interacts successively with two or three screens or interfaces: file-management screen 630, multimedia-content screen 640, and multimedia-play screen 650.

FIG. 6A depicts file-management screen 630 in display 325 of client 106. This screen is accessed from the “idle” mode of client 106 by pressing “sel” key 620.

File-management screen 630 provides the directory structure for multimedia content that can be presented via client 106. In this embodiment, a “file” icon appears for each of four types of multimedia content: music 631, video 633, pictures 635, and web 637. Scroll bar 639 appears in this screen as well.

With file-management screen 630 active, “next” key 626 and “back” key 628 are used to navigate through the directory. Pressing “sel” key 620 selects the desired type of content for access.

FIG. 6B depicts multimedia-content screen 640. This screen is accessed by selecting one of the types of multimedia content (icons 631-637) in file-management screen 630. In some embodiments, the specific layout of multimedia-content screen 640 varies with the type of multimedia content that has been selected for access. Those skilled in the art will be able to configure multimedia-content screen 640 as a function of the media type being accessed. In some other embodiments, the layout of multimedia-content screen 640 does not change as a function of multimedia-content type.

In the illustrative embodiment that is depicted in FIG. 6B, multimedia content screen 640 displays music files as listing 645 of song titles. The user navigates to a particular content item using “forward” key 626 or “back” key 628. The “active” content item will be highlighted.

This screen enables a user to “preserve” or “un-preserve” a content item. To preserve an item, the user presses “sel” key 620. “Check” icon 643 appears in “box” icon 641 to indicate that the particular content item has been preserved. If an item has “preserved” status, pressing “sel” key 620 will un-preserve it. The absence of check icon 643 in box 641 indicates that a particular item is not preserved. Scroll bar 647 appears in this screen as well.

In some embodiments, pressing “stop/pause” key 624 in this screen, with a content item active, will cause more information regarding the content item to be presented. For instance, continuing with the example of a list of song titles appearing in multimedia-content screen 640, pressing “stop/pause” key 624 might call up the recording artist for the song and the album from which the song is sourced, etc.

From multimedia-content screen 640, and with a content item selected, pressing “play” key 622 changes the state of client 106 wherein multimedia-play screen 650 is displayed and the selected item is presented (e.g., played, etc.).

When client 106 is in the multimedia-play state, “next” key 626 and “back” key 628 function as volume “up” and volume “down,” respectively. “Stop/pause” key 624 stops/pauses the presentation, and “play” key 622 continues presentation if it is stopped or paused.

When the content is a music file, multimedia-play screen 650 displays graphic equalizer pattern 651 or other image (e.g. random pattern, etc.) When the content item is video, the screen displays the video. When the content item is a picture, the screen displays a picture and when the content item is a web page, the screen displays a web page, etc. Furthermore, multimedia-play screen 650 includes “box” icon 653, which, by the presence or absence of “check” icon 655, indicates the status of the content item being presented as “preserved” or “un-preserved,” respectively. Pressing “sel” key 620 when client 106 is in multimedia-play state un-preserves or preserves the content item being presented.

When presentation of the content item is complete, client 106 reverts to multimedia content state, so that another content item can be selected for presentation.

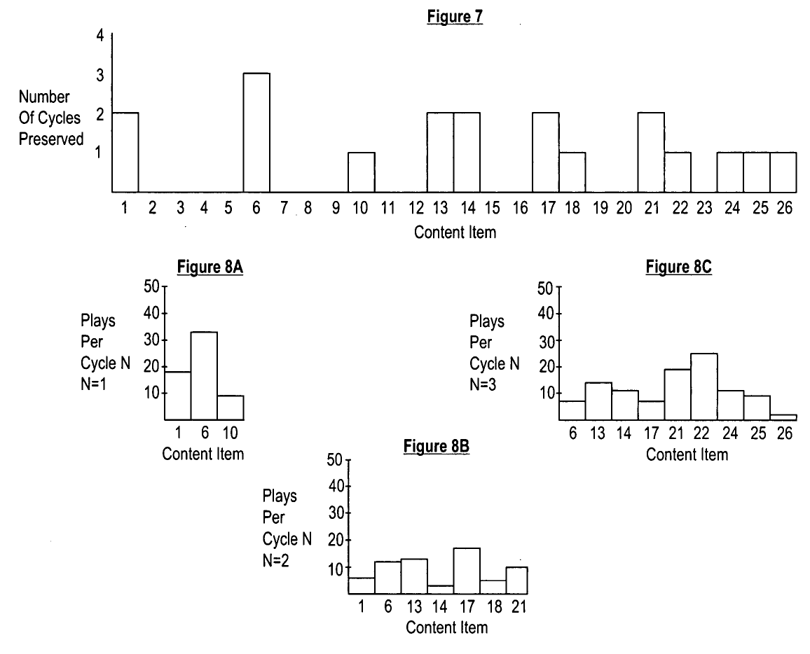

It has been disclosed that at least two different types of feedback are provided to server 110. One type of feedback pertains to which particular content items the user has chosen to preserve. A second type of feedback is based on the user's pattern of use of preserved multimedia content. FIGS. 7 and 8A through 8C depict examples of the second type of feedback.

FIG. 7 tracks the number of cycles that each content item is preserved, wherein a cycle is defined as the time between subsequent transfers of content. Items that are preserved for a relatively greater number of cycles (“older items”) are deemed to be relatively more desirable to a user than items that have been preserved for relatively fewer cycles (“younger items”). These older items, therefore, should be weighted more heavily by server 110 than younger items in the selection of future content.

FIGS. 8A through 8C track the number of presentations (e.g., “plays” for music, etc.) of a preserved content item during a given cycle. FIG. 8A tracks plays of preserved items during the first cycle, FIG. 8B tracks plays of preserved items during the second cycle, and FIG. 8C tracks plays of preserved items during the third cycle.

Items that are presented relatively more frequently during a cycle are deemed to be relatively more desirable to a user than items that have been presented relatively fewer times during the cycle. The items that are more frequently presented should, therefore, be weighted more heavily than items that are presented less frequently in the selection of future content. For example, in FIG. 8A, content item 6 is played most frequently, followed by content item 1, and then content item 10. Therefore, the attributes of content item 6 should be weighted more heavily in the selection of future content than the attributes of content items 1 or 10.

This second type of feedback is tracked by client 106. In other words, no explicit feedback is required from the user. This is desirable due to the problematic nature of communicating non-verbally using a hand-held device. This information pertaining to usage patterns is transmitted, as per operation 426 (FIG. 4), from client 106 to server 110 as a second type of feedback.

In some embodiments, the feedback from one or more users is applied to other users, wherein all the users are part of a defined group. The group, for example, might be users with a similar interest (e.g., sports, hobbies, etc) or persons that are otherwise similarly situated in terms of vocation, etc. The assumption is that due to a similarity of interest or situation, the content selections and patterns of content usage of one or more members of the group is likely to be relevant to other members of the group.

In some embodiments, client 106 includes a “favorite location” key or icon. If an icon is used, it can be made to appear in any, some, or all of the states (i.e., screens) of client 106. Selecting this key or icon designates a current location as a “favorite location.” This features functions in concert with a location determining system, such as assisted GPS. More than one location can be designated as a favorite location. The details of the way in which a geographic location defined, for example, by geo-coordinates, is correlated to a particular place, such as a stadium, is known to those skilled in the art.

In addition to or as an alternative to explicitly defining a “favorite location,” in some embodiments, a “favorite location” is implicitly or automatically defined based on analysis of usage patterns of the user.

For implicit or automatic designation, the location of client 106 is obtained on a periodic basis. This is performed automatically in conjunction with a location-determining system (e.g., assisted GPS, etc.). Each time a location is obtained, it is stored in memory. Software analyzes the frequency that client 106 is present each recorded location and/or the time that client 106 is present at each recorded location. The software identifies locations that are visited relatively more frequently and/or locations at which the client spends relatively more time. Those location(s) are automatically designated as “favorite places” by client 106 or server 110.

A list of favorite locations, whether explicitly or implicitly defined, is maintained in client 106 and/or in user database 232 at server 110.

In accordance with the illustrative embodiment of the invention, server 110 transmits information that is relevant to one or more favorite locations to client 106. For example, if a stadium is designated (explicitly or implicitly) as a favorite location, the server might transmit a schedule of events for the stadium.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed is:

1. A method comprising:
sending first content to a client, wherein said first content comprises a plurality of first-content items, and wherein said first-content is stored in memory at said client and occupies a first amount of said memory;
receiving feedback from said client, wherein said feedback comprises an indication of which first-content items have been preserved in said memory by a user of said client; and
selecting second content to be sent to said client, wherein selection of said second content is based on said feedback.

2. The method of claim 1 further comprising sending said second content to said client, wherein:
(1) said second content occupies a second amount of said memory; and
(2) said second amount of said memory corresponds to an amount of memory that is occupied by first-content items that have not been preserved in said memory.

3. The method of claim 1 further comprising sending said second content to said client, wherein said second content overwrites first-content items that have not been preserved in said memory.

4. The method of claim 1 wherein said feedback comprises a frequency or relative frequency at which individual first-content items have been accessed.

5. The method of claim 1 wherein said feedback comprises a time or relative time that individual first-content items are preserved in said memory.

6. The method of claim 1 wherein said first content fills all memory that is available for content storage.

7. The method of claim 1 further comprising sending third content to said client, wherein said third content relates to a location that has been identified as a favorite place.

8. The method of claim 1 further comprising:
receiving a request to designate said client and a second client as members of a group;
sending third content to said second client, wherein said third content comprises a plurality of third-content item;
receiving feedback from said second client, wherein said feedback comprises user preferences relating to said third-content items; and
selecting fourth content to be sent to said second client, wherein selection of said fourth content is based on said feedback from said client relating to said first-content items and is also based on said feedback from said second client relating to said third-content items.

9. The method of claim 8 wherein said second content to be sent to said client is based on said feedback from said client relating to said first-content items and is also based on feedback from said second client relating to said third-content items, and wherein at least some of said second content and at least some of said fourth content is the same.

10. A method comprising:
receiving first content from a server;
storing said first content in a plurality of storage locations;
receiving a request to preserve a first subset of said first content;
preserving said first subset of said first content in a subset of said plurality of storage locations; and
sending feedback to said server, wherein said feedback comprises user preferences relating to said first content.

11. The method of claim 10 further comprising receiving second content from said server, wherein said second content is selected by said server based on said feedback, and wherein said second content comprises an amount of content that is suitable for storing in available storage locations, wherein available storage locations are defined as the difference between said plurality of storage locations and said subset thereof.

12. The method of claim 10 further comprising:
receiving second content from said server, wherein said second content is selected by said server based on said feedback; and
storing said second content in a second subset of said plurality of storage locations by overwriting said first content that is stored in said second subset of said plurality of storage locations, wherein said first subset of storage locations and said second subset of storage locations are disjoint.

13. The method of claim 10 wherein said first content comprises a plurality of first-content items, and further comprising receiving a request from a user to present a first-content item.

14. The method of claim 13 wherein sending feedback further comprises providing an indication of which first-content items are members of said first subset.

15. The method of claim 13 wherein sending feedback further comprises providing an indication of a frequency or a relative frequency at which individual first-content items that are members of said first subset have been presented.

16. The method of claim 13 further comprising receiving a request to change a designation, from “preserve” to “do not preserve,” of at least one of said first-content items that is a member of said first subset.

17. The method of claim 16 wherein sending feedback comprises providing a time or relative time that individual first-content items are preserved in said memory.

18. The method of claim 10 further comprising receiving a request to designate a present location as a favorite location.

19. The method of claim 10 further comprising designating a location as a favorite location based on one or more metrics selected from the group consisting of a frequency of visits to said location or time spent at said location.

20. The method of claim 10 wherein sending feedback requires no action from a user of said client other than making said request to preserve said first subset of said first content.

21. An apparatus comprising:
a receiver for receiving a plurality of content items from a server;
a memory for storing said plurality of content items;
circuitry for presenting said content to a user;
a selector by which a user preserves at least some of said content items in said memory; and
a feedback mechanism, wherein said feedback mechanism compiles and sends feedback to said server.

22. The apparatus of claim 21 wherein said selector comprises a key, wherein said key is actuated by said user.

23. The apparatus of claim 21 wherein said feedback mechanism provides an indication of which content items have been preserved and which have not been preserved.

24. The apparatus of claim 21 wherein said feedback mechanism provides an indication of an amount of memory that is occupied by content items that have not been preserved.

25. The apparatus of claim 21 further comprising a key that designates a present location as a favorite location.

26. The apparatus of claim 21 further comprising software for designating a location as a favorite location, wherein said designation is based on a frequency of visits to said location or elapsed time spent at said location.
